(19) United States
(12) Patent Application Publication
(10) Pub. No.: US 2012/0081537 A1
(43) Pub. Date: Apr. 5, 2012

(54) CAMERA PROTECTIVE SYSTEM AND METHOD

(75) Inventors: Sebastien Arcand, Saint-Augustin-de-desmaures (CA); Marc-Andre Hebert, Quebec (CA)

(73) Assignee: GENERAL ELECTRIC COMPANY, Schenectady, NY (US)

(21) Appl. No.: 12/897,157

(22) Filed: Oct. 4, 2010

(51) Int. Cl. H04N 7/18

(52) U.S. Cl. 348/86; 348/E07.085

(57) ABSTRACT

A user protection system, a machine including a user protection system, and a method of protecting a user of a machine are disclosed. In an embodiment, a user protection system is provided including at least one camera directed to a protected area of the machine; a computing device operably coupled to the at least one camera, a program product stored in a memory of the computing device which when executed, analyzes at least one image of the protected area captured by the camera and transmitted in real time to the computing device, and a relay coupling operably connecting the computing device with a shut-off control on the machine, wherein, in a case in which at least a part of a user is detected at least partially within the protected area, the computing device transmits a command causing the machine to stop.

### BACKGROUND OF THE INVENTION

The invention relates generally to user protection systems for machines and industrial equipment. More particularly, the invention relates to a camera protection system, and a machine including a camera protection system.

Industrial equipment and machines often include moving parts that pose a safety hazard for individuals who operate them. One such machine is a press brake, a machine typically used to bend sheet metal. A press brake typically includes a pair of vertical frames forming the ends of the press brake machine, a table mounted at the bottom of the frames, and an upper boom or press movably mounted to the top of the frames. A bottom tool is mounted to the table, and a top tool is mounted on the upper beam.

A piece of malleable sheet metal to be pressed or formed into a desired shape is fed into the press brake on the table and aligned over a tool called a die. The press brake lowers the boom onto the sheet metal and applies force, pressing the sheet metal into the die to bend the sheet into a cold-formed metal object. Typical sheet metals which may undergo this process include but are not limited to aluminum, steel, and copper, of which varying thicknesses and sizes may be used.

Various types of dies may be used for forming jobs of varying complexity. In many cases, raising and lowering of the boom is controlled using a computer. Press brakes may be described by various basic parameters, including the force or tonnage, working length, amplitude or stroke of the boom, lateral distance between the frame uprights or side housings, distance to the back gauge, and work height. Either mechanical, pneumatic, hydraulic, or servo-electric force may be applied.

Various conventional safety systems have been designed to protect operators of machines, such as press brakes and other industrial equipment having a user-accessible working zone, from risk of injury. Operators' hands and other extremities or body parts may be caught between moving parts in the working zone, which can result in crushing or amputation of the extremity or other injury. Guards are typically unfeasible to prevent such injury for machines which are used with varied thicknesses and sizes of materials.

In order to prevent these risks, one conventional solution has been a bi-manual command and proximity detector, used to stop a press brake at a pre-set material thickness plus, e.g., 6 mm to protect a user's finger. Injury to a hand or finger may still result, however. Laser beams have also been used. In this case, in a teaching mode, the machine is operated to produce a first formed piece, receiving input as to which laser beams will be cut during normal operation. To form subsequent pieces identical to the first formed piece, the machine is operated in an operation mode. The laser beam is used to detect any discrepancy between teaching mode and operation mode, and where a discrepancy is detected, the press brake is stopped. However, this protection system does not provide any measure of protection while operating in the teaching mode. Where an operator uses a press brake to form individual, unique pieces, no protection can be provided, as each piece would be formed in a teaching mode rather than an operation mode for making identical replica pieces.

### BRIEF DESCRIPTION OF THE INVENTION

In order to address these and other needs in the art, a camera user-protection system is described herein.

A first aspect of the disclosure provides a protection system for a machine, the protection system comprising: at least one camera directed to a protected area of the machine; a computing device operably coupled to the at least one camera, the computing device including a memory, a processing unit, and a program product stored in the memory which when executed by the processing unit, analyzes at least one image of the protected area captured by the at least one camera and transmitted in real time to the computing device, and a relay coupling operably connecting the computing device with a shut-off control on the machine. In a case in which an object is detected at least partially within the protected area of the machine in the at least one image, the computing device transmits a command to the machine using the relay coupling, the command causing the machine to stop.

A second aspect of the disclosure provides a machine having a working zone, the machine comprising: a protection system for the working zone, the protection system including: at least one camera directed to a protected area of the machine; a computing device operably coupled to the at least one camera, the computing device including a memory, a processing unit, and a program product stored in the memory which when executed by the processing unit, analyzes at least one image of the protected area captured by the at least one camera and transmitted in real time to the computing device, and a relay coupling operably connecting the computing device with a shut-off control on the machine. In a case in which an object is detected at least partially within the protected area of the machine in the at least one image, the computing device transmits a command to the machine using the relay coupling, the command causing the machine to stop.

A third aspect of the disclosure provides a method of providing protection for a machine, the method comprising: providing at least one camera directed to a protected area of the machine; operably coupling a computing device to the at least one camera, the computing device including a memory, a processing unit, and a program product loaded in the memory which when executed by the processing unit, analyzes at least one image of the protected area captured by the at least one camera; providing a relay coupling operably connecting the computing device to a shut-off control for the machine; transmitting at least one image of the protected area from the camera to the computing device; and on the computing device, analyzing the at least one image of the protected area. In a case in which an object is detected at least partially within the protected area, transmitting a command using the relay coupling from the computing device to the machine shut-off control to halt the machine.

### BRIEF DESCRIPTION OF THE DRAWINGS

These and other aspects, advantages and salient features of the invention will become apparent from the following detailed description, which, when taken in conjunction with the annexed drawings, where like parts are designated by like reference characters throughout the drawings, disclose embodiments of the invention.

FIG. 1 shows a press brake according to an embodiment of the invention.

FIG. 2 depicts a protective system according to an embodiment of the invention.

FIG. 3 depicts a method for protecting a user of a machine according to embodiments of the invention.

### DETAILED DESCRIPTION OF THE INVENTION

At least one embodiment of the present invention is described below in reference to its application in connection with the operation of an industrial machine. Although embodiments of the invention are illustrated relative to a machine in the form of a press brake, it is understood that the teachings are equally applicable to other machines and pieces of industrial equipment including, but not limited to, shear presses. Further, at least one embodiment of the present invention is described below in reference to a nominal size and including a set of nominal dimensions. However, it should be apparent to those skilled in the art that the present invention is likewise applicable to any suitable machine and/or piece of equipment. Further, it should be apparent to those skilled in the art that the present invention is likewise applicable to various scales of the nominal size and/or nominal dimensions.

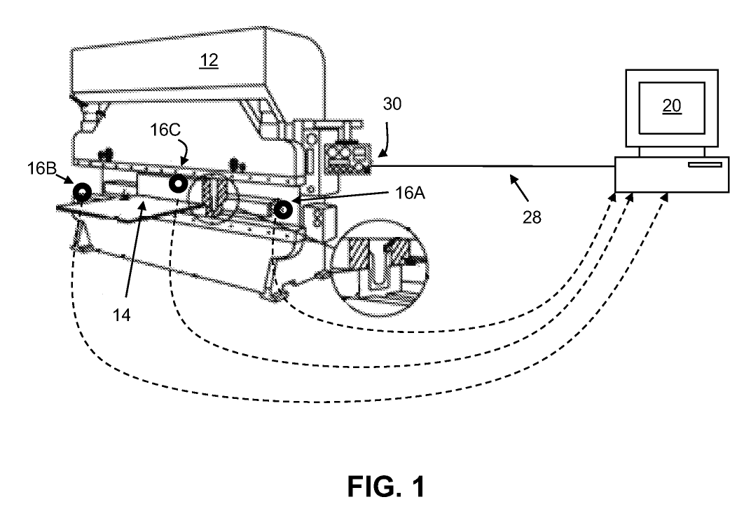

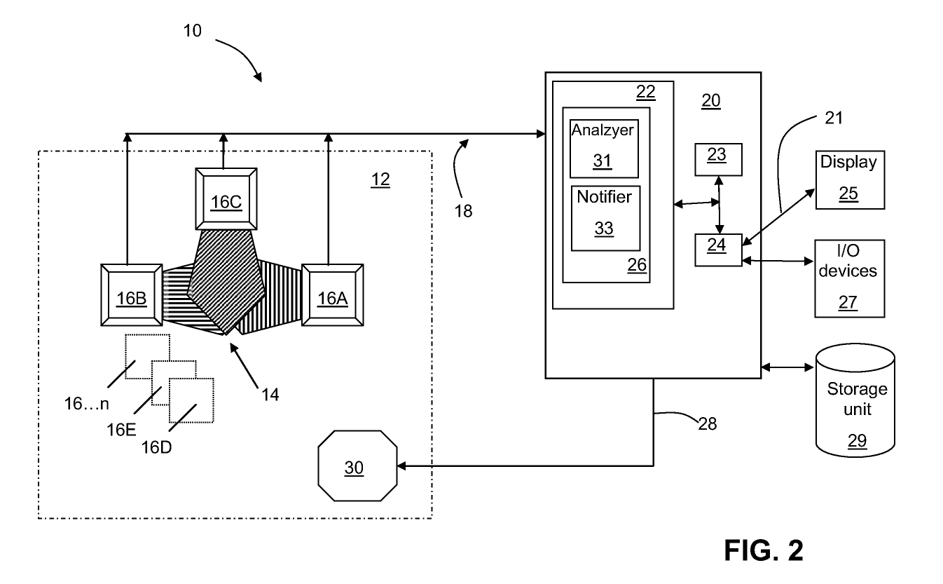

As indicated above, aspects of the invention provide a user protection system, depicted in FIG. 2, and an industrial machine including a user protection system, depicted in FIG. 1.

As shown in FIG. 1, user protection system 10 includes at least one camera 16 directed to protected area 14 of machine 12. Protected area 14 may be any region or area of machine 12 where moving parts of machine 12 may pose a safety hazard for a user. In the case of a press brake, protected area 14 is typically the accessible work zone, e.g., the region where the boom is lowered onto sheet metal. Protected area 14 may further vary in location and size, in dependence upon the size of the material to be worked upon, the shape of the material to be worked upon, and other parameters.

The number of cameras 16 may vary according to different embodiments of the invention. Various embodiments may include one, two, three, four, or more cameras 16 directed to protected area 14. FIG. 2 depicts an embodiment having three cameras 16A-C, in addition to fourth, fifth, and subsequent additional cameras 16D, 16E, and 16 . . . n depicted in phantom. In that embodiment, a first camera 16A and a second camera 16B are placed at opposite ends of protected area 14, about 180° apart. First and second cameras 16A, 16B are each directed to the protected area 14, the protected area 14 being located between the first and second cameras 16A, 16B. A third camera 16C, is oriented perpendicularly (90°) relative to the first and second cameras 16A, 16B, and is directed toward protected area 14. This embodiment represents one potential configuration, however; it is not intended to be limiting. Many other orientations, arrangements, and quantities of cameras 16A-16 . . . n may also be used in accordance with the other embodiments of invention in order to monitor the entirety of protected area 14.

Cameras 16A-C may be movably affixed to machine 12. The positions of cameras 16A-C may be adjusted in order to maintain visualization of protected area 14 while accommodating the formation of a variety of differently sized and shaped pieces. Alternatively, cameras 16 may be immovably affixed to machine 12.

During operation of machine 12, cameras 16 capture at least one image of protected area 14. In some embodiments, cameras 16 may be video-capable, such as, e.g., a webcam, and the image may be a live video feed. Alternatively, the image may be a still image or a series of still images. In other embodiments, cameras 16 may be infrared cameras or other cameras capable of thermal imaging. Cameras 16 transmit the at least one image to computing device 20 in real time via coupling 18, which operably connect cameras 16 to computing device 20. Alternatively, any other form of transmission, including wireless transmissions, may be used.

As shown, computing device 20 includes a processing unit 24, a memory 22, input/output (I/O) interfaces 23 operably connected to one another by pathway 21, which provides a communications link between each of the components in computing device 20. Further, computing device 20 is shown in communication with display 25, external I/O devices/resources 27, and storage unit 29. Display 25 displays an image(s) of protected area 14 cameras 16. I/O devices 27 can comprise one or more human I/O devices, such as a mouse, keyboard, joystick, or other selection device, which enable a human user to interact with computing device 20 and/or one or more communications devices to enable a device user to communicate with computing device 20 using any type of communications link.

In general, processing unit 24 executes computer program product 26 which provides the functions of computing device 20. These modules, including an image analyzer 31 and a notifier 33, are stored in memory 22 and/or storage unit 29, and perform the functions and/or steps of the present invention as described herein. Memory 22 and/or storage unit 29 can comprise any combination of various types of computer readable data storage media that reside at one or more physical locations. To this extent, storage unit 29 could include one or more storage devices, such as a magnetic disk drive or an optical disk drive. Still further, it is understood that one or more additional components not shown in FIG. 2 can be included in computing device 20, including analysis of the at least one image of protected area 14 captured by cameras 16 and transmitted in real time to computing device 20. Additionally, in some embodiments one or more external devices 27, display 25, and/or storage unit 29 could be contained within computing device 20, rather than externally as shown.

Computing device 20 can comprise one or more general purpose computing articles of manufacture capable of executing program code, such as program 26, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, program 26 can be embodied as any combination of system software and/or application software.

Further, program 26 can be implemented using a set of modules 31, 33. In this case, a modules 31, 33 can enable computing device 20 to perform a set of tasks used by program 26, and can be separately developed and/or implemented apart from other portions of program 26. As used herein, the term “component” means any configuration of hardware, with or without software, which implements the functionality described in conjunction therewith using any solution, while the term “module” means program code that enables a computing device 20 to implement the actions described in conjunction therewith using any solution. When fixed in memory 22 or storage unit 29 of a computing device 20 that includes a processing unit 24, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computing device 20.

When computing device 20 comprises multiple computing devices, each computing device can have only a portion of program 26 fixed thereon (e.g., one or more modules 31, 33). However, it is understood that computing device 20 and program 26 are only representative of various possible equivalent computer systems that may perform a process described herein. To this extent, in other embodiments, the functionality provided by computing device 20 and program 26 can be at least partially implemented by one or more computing devices that include any combination of general and/or specific purpose hardware with or without program code. In each embodiment, the hardware and program code, if included, can be created using standard engineering and programming techniques, respectively.

Regardless, when computing device 20 includes multiple computing devices, the computing devices can communicate over any type of communications link. Further, while performing a process described herein, computing device 20 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As noted, computing device 20 includes an image analyzer 31 module for analyzing an image of protected area 14 of machine 12. In some embodiments, the analysis conducted by image analyzer 31 may include identifying a movement within the protected area, which may indicate that an operator's body part or other foreign object has entered protected area 14 and may be at risk. In other embodiments, the analysis conducted by image analyzer 31 may include identifying a presence of a previously specified color within the protected area, as represented by pixels of a certain color in the image(s). The previously specified color may be, e.g., that of a color of glove that operators wear while operating the machine. For example, if the machining process requires the operator to wear blue gloves, the color blue may be pre-set for detection by analyzer 31. In further embodiments, the analysis conducted by image analyzer 31 may include identifying a presence of a specified shape within the protected area. The specified shape may be that of a human arm, hand, or other body part or object such as another piece of machinery or a tool. Identification of such an object may indicate the presence of an operator's body part or other object has entered protected area 14 and may be at risk. In still further embodiments, the analysis conducted by image analyzer 31 may include identifying a presence of an object having a specified temperature within the protected area. The specified temperature may be set to detect the temperature of a human body part against the ambient temperature of the room or the temperature of machine 12, or another temperature. In further embodiments, an ultraviolet or infrared light source may be directed toward protected area 14. A user, a part of a user, or another object present in protected area 14 may reflect the UV or IR light generated by the light source to cameras 16. Analysis and/or quantification of this reflection may also be used to determine the presence of a user, a part of a user, or another object in protected area 14.

In additional embodiments, the analysis conducted by image analyzer 31 may include any combination of one or more of the foregoing analyses, or another analysis.

As shown in FIGS. 1-2, computing device 20 is operably connected via relay coupling 28 to a shut-off control 30 on machine 12. Relay coupling 28 may include a Solid State Relay, a metal-oxide-semiconductor field-effect transistor (MOSFET), or any other switching device.

In a case in which image analyzer 31 identifies, through any one or more of the foregoing analyses, a previously specified motion, color, shape, temperature, reflection, or other indicator that suggests that at least a part of a user or another object is present within protected area 14 of machine 12, notifier 33 transmits via relay coupling 28 a command to shut-off mechanism 30 of machine 12, the command automatically causing machine 12 to stop operating. In another embodiment, notifier 33 may set off an alarm warning a user.

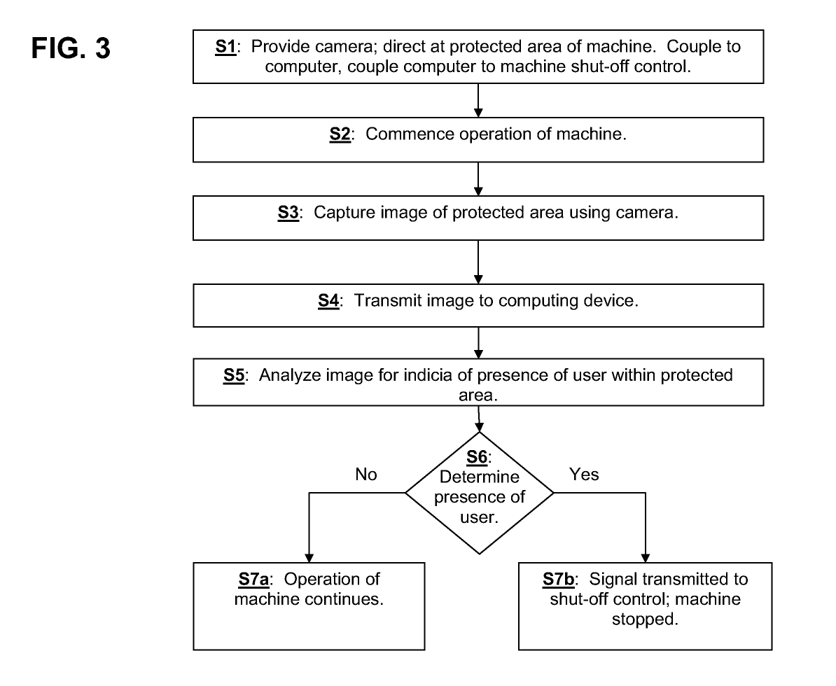

As depicted in FIG. 3, a method of protecting a user of machine 12 is also provided. In step S1, at least one camera 16 is provided and directed to protected area 14 of machine 12, and operably coupled to computing device 20. Computing device 20 is further operably connected via relay coupling 28 to shut-off control 30 for machine 12. In step S2, operation of machine 12 commences.

In step S3, cameras 16 capture at least one image of protected area 14. The image may be either a live video feed, or a still image or series of still images. In any event, in step S4, coupling 18 transmits the at least one image to computing device 20.

In step S5, analyzer 31 analyzes the at least one image of protected area 14 on computing device 20. In various embodiments, the analysis may include identifying one or more of: a movement, the presence of an object having a previously specified color, an object having a previously specified shape, an object reflecting a previously specified amount or type of light, or an object having a previously specified temperature within the protected area, or any other pre-specified indicator which may indicate the presence of an operator's body part or other object has entered protected area 14 and may be at risk.

In Step S5, the image of protected area 14 may be passed through a first stage by thresholding the image, to determine whether a pixel in the image represents a foreign object or a portion of the user of the machine. For example, to determine if a pixel is depicting the hands of the user, analyzer 31 may compare the pixel with a previously set threshold. The threshold can refer to color, temperature, and/or light reflection level or other parameter. If the pixel depicts, e.g., a temperature or light reflection level higher than the threshold it, may identify the pixel as depicting, e.g., a hand of the user. A binary image is produced for a second stage of analysis. Next, a blob extraction is performed on the resulting binary image from the thresholding step. Finally feature detection is performed on the image to analyze the size, shape and corners of the previously-detected blob, and determine whether a previously-specified feature shape is present in the image. In a further embodiment, an image taken by a camera 16 . . . n of an area outside of protected area 14, which may be used to predict movement outside of protected area 14, to anticipate the user's or the object's movements, and thus detect the user or object before it enters protected area 14. In additional embodiments, the analysis conducted by image analyzer 31 may include any combination of one or more of the foregoing analyses.

In step S6, analyzer 31 arrives at a determination as to whether a user is present within protected area 14. If the criteria of color, temperature, reflection, shape, size and/or movement exceed pre-determined threshold levels, analyzer 31 concludes that the image of protected area 14 includes the user or foreign object in protected area 14.

In step S7a, if the determination is negative, i.e., “no,” or “not present” at step S6, analyzer 31 allows machine 12 to continue to operate in a conventional fashion. In a case in which at least a part of a user is detected at least partially within protected area 14 as described herein, i.e., “yes” at step S6, notifier 33 transmits a command from computing device 20 to machine shut-off control 30 via relay coupling 28, immediately and automatically halting operation of machine 12 at step S7b.

It is understood that aspects of the invention can be implemented as part of a business method that performs a process described herein on a subscription, advertising, and/or fee basis. That is, a service provider could offer a method for providing protection for a machine as described herein. In this case, the service provider can manage (e.g., create, maintain, support, etc.) a computer system, such as computing device 20 (FIG. 2), that performs a process described herein for one or more customers. In return, the service provider can receive payment from the customer(s) under a subscription and/or fee agreement, receive payment from the sale of advertising to one or more third parties, and/or the like.

Technical effects of the various embodiments of the present invention include providing protection for users of machines and other industrial equipment during operation of the machine to form individual, unique machined pieces from raw materials having different sizes and thickness, in addition to when operating the machine to form mass produced pieces. Other technical effects associated with the various embodiments of the present invention include the ability to avoid injury to a user and/or damage to tools or other machinery during operation of a machine or piece of industrial equipment.

As used herein, the terms “first,” “second,” and the like, do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to about 25 mm, or, more specifically, about 5 mm to about 20 mm,” is inclusive of the endpoints and all intermediate values of the ranges of “about 5 mm to about 25 mm,” etc.).

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A protection system for a machine, the protection system comprising:
at least one camera directed to a protected area of the machine;
a computing device operably coupled to the at least one camera, the computing device including
a memory,
a processing unit, and
a program product stored in the memory which when executed by the processing unit, analyzes at least one image of the protected area captured by the at least one camera and transmitted in real time to the computing device, and
a relay coupling operably connecting the computing device with a shut-off control on the machine,
wherein, in a case in which an object is detected at least partially within the protected area of the machine in the at least one image, the computing device transmits a command to the machine using the relay coupling, the command causing the machine to stop.

2. The protection system of claim 1, wherein the at least one camera further comprises a first camera, a second camera, and a third camera.

3. The protection system of claim 2, wherein the first camera and the second camera are spaced about 180° apart, the first and second cameras each directed to the protected area, the protected area being located between the first and second cameras, and
wherein the third camera is spaced about 90° from each of the first and second cameras, and is directed toward the protected area.

4. The protection system of claim 1, wherein the at least one camera further comprises four or more cameras.

5. The protection system of claim 1, wherein the at least one camera is movably affixed to the machine.

6. The protection system of claim 1, wherein the at least one image captured by the camera further comprises a live video feed.

7. The protection system of claim 5, wherein the analyzing includes identifying a movement within the protected area.

8. The protection system of claim 1, wherein the analyzing includes identifying a presence of a specified color within the protected area.

9. The protection system of claim 1, wherein the analyzing includes identifying a presence of a specified feature shape within the protected area.

10. The protection system of claim 1, wherein the analyzing includes identifying a presence of an object having a specified temperature within the protected area.

11. The protection system of claim 1, wherein the machine comprises one of the following: a press brake or a shear press.

12. A machine having a working zone, the machine comprising:
a protection system for the working zone, the protection system including:
at least one camera directed to a protected area of the machine;
a computing device operably coupled to the at least one camera, the computing device including
a memory,
a processing unit, and
a program product stored in the memory which when executed by the processing unit,
analyzes at least one image of the protected area captured by the at least one camera and transmitted in real time to the computing device, and
a relay coupling operably connecting the computing device with a shut-off control on the machine,
wherein, in a case in which an object is detected at least partially within the protected area of the machine in the at least one image, the computing device transmits a command to the machine using the relay coupling, the command causing the machine to stop.

13. The machine of claim 12, wherein the at least one camera further comprises at least three cameras.

14. The machine of claim 12, wherein the at least one camera is movably affixed to the machine.

15. The machine of claim 12, wherein the analyzing includes identifying a presence of one or more of:
a movement within the protected area,
a specified color within the protected area,
an object having a specified temperature within the protected area, or
an object having a specified temperature within the protected area.

16. The machine of claim 12, wherein the machine comprises one of a press brake or a shear press.

17. The machine of claim 12, wherein the at least one image captured by the camera further comprises a live video feed.

18. A method of providing protection from a machine, the method comprising:
providing at least one camera directed to a protected area of the machine;
operably coupling a computing device to the at least one camera, the computing device including
a memory,
a processing unit, and
a program product loaded in the memory which when executed by the processing unit, analyzes at least one image of the protected area captured by the at least one camera;
providing a relay coupling operably connecting the computing device to a shut-off control for the machine;
capturing on the camera and transmitting at least one image of the protected area from the camera to the computing device;
on the computing device, analyzing the at least one image of the protected area;
in a case in which an object is detected at least partially within the protected area, transmitting a command using the relay coupling from the computing device to the machine shut-off control to halt the machine.

19. The method of claim 18, wherein the analyzing includes identifying a presence of one or more of:
a movement within the protected area,
a specified color within the protected area,
an object having a specified temperature within the protected area, or
an object having a specified temperature within the protected area.

20. The method of claim 18, further comprising movably positioning the at least one camera on the machine, wherein the position is adjustable.
